(19) United States
(12) Patent Application Publication
(10) Pub. No.: US 2007/0201451 A1
(43) Pub. Date: Aug. 30, 2007

(54) Service exchange in a VoIP to telephony bridging network

(75) Inventor: James D. Bennett, San Clemente, CA (US)

Correspondence Address: GARLICK HARRISON & MARKISON, P.O. BOX 160727, AUSTIN, TX, 78716-0727, US

(73) Assignee: Broadcom Corporation, a California Corporation, Irvine, CA (US)

(21) Appl. No.: 11/386,586

(22) Filed: Mar. 22, 2006

Related U.S. Application Data
(63) Continuation-in-part of application No. 11/348,962, filed on Feb. 7, 2006.
(63) Continuation-in-part of application No. 11/348,814, filed on Feb. 7, 2006.
(63) Continuation-in-part of application No. 11/348,743, filed on Feb. 7, 2006.

(51) Int. Cl. H04L 12/66

(52) U.S. Cl. 370/356

(57) ABSTRACT

An infrastructure that supports both Voice over Internet Protocol (VoIP) telephony via the Internet and Public Switched Telephone Network (PSTN) telephony via the PSTN. A plurality of client telephony bridging devices communicatively couple to both the Internet and to the PSTN and are operable to bridge calls between the Internet and the PSTN. Server processing circuitry communicatively couples to the plurality of client telephony bridging devices and is operable to receive a voice call setup request from a calling voice terminal via the Internet or PSTN. The server processing circuitry is operable to select a servicing telephony bridging device from the plurality of client telephony bridging devices. The servicing client telephony bridging device is operable to bridge an incoming call for the calling voice terminal between the Internet and the PSTN.

### CROSS REFERENCES TO RELATED APPLICATIONS

This application is a continuation-in-part of the following co-pending applications:

1. Utility application Ser. No. 11/348,962, filed on Feb. 7, 2006, and entitled “TELEPHONE SUPPORTING BRIDGING BETWEEN A PACKET SWITCHED NETWORK AND THE PUBLIC SWITCHED TELEPHONE NETWORK”;

2. Utility application Ser. No. 11/348,814, filed on Feb. 7, 2006, and entitled “COMPUTING DEVICE SUPPORTING BRIDGING BETWEEN A PACKET SWITCHED NETWORK AND THE PUBLIC SWITCHED TELEPHONE NETWORK”; and

3. Utility application Ser. No. 11/348,743, filed on Feb. 7, 2006, and entitled “SET TOP BOX SUPPORTING BRIDGING BETWEEN A PACKET SWITCHED NETWORK AND THE PUBLIC SWITCHED TELEPHONE NETWORK”.

### BACKGROUND OF THE INVENTION

1. Technical of the Invention

This invention relates generally to communication systems and more particularly to Voice over Internet Protocol (VoIP) telephony and to Public Switched Telephone Network (PSTN) telephony.

2. Description of Related Art

Voice telephony has been known for many years. Initially, voice telephony was supported by dedicated conductors between telephones. Then, voice telephony was enabled by operators manually switching connectors to create and tear down circuits between telephones. As technology advanced, mechanical components performed the switching operations to create and tear down circuits between telephones. With advancing technology, computers and semiconductor components replaced the mechanical components to perform circuit switching duties. Networks created using this circuit-switched technology are generally known as the Public Switched Telephone Network (PSTN). Generally, the PSTN provides a circuit-switched, time-divided connection between telephones.

Packet data communications, such as those supported by the Internet, differ from circuit-switched communications. With packet data communications, a source device forms a data packet, transmits the data packet to a packet data network, and based upon a destination address, e.g., Internet Protocol (IP) address of the data packet, the packet data network passes the data packet to a destination device. As the Internet and other packet data networks grew in popularity, packet switched voice telephony was developed. One common type of packet switched voice telephony is Voice over Internet Protocol (VoIP) telephony. When VoIP telephony was first introduced, the data packet transmission latency of the Internet and of other servicing networks caused the quality of VoIP telephony to be significantly worse than that of PSTN telephony. Over time, packet data transmission latency of the Internet and of other servicing packet data networks has decreased. Now, VoIP telephony provides service quality equal to or better than VoIP telephony in many cases.

Recently developed VoIP telephony applications enable computer users to establish non-toll VoIP telephone calls across the Internet. Compared to PSTN telephony VoIP telephony of this type is significantly less expensive, particularly for overseas calls. However, only a limited number of people have a computer upon which this VoIP telephony application may be loaded and have Internet access of a quality that will support the VoIP telephony application.

In order to gain some advantages of VoIP telephony but still service consumers having PSTN telephones, VoIP telephony service providers typically deploy VoIP gateways. The VoIP gateways bridge communications between the PSTN (PSTN telephony call) and the Internet (VoIP telephony call). VoIP telephony service providers typically extract a toll for servicing a call via the VoIP gateway bridge, thus destroying in part the low cost attractiveness of VoIP telephony. Thus, a need exists for systems and methods of operations that overcome the shortcomings of these prior telephony systems.

### BRIEF SUMMARY OF THE INVENTION

The present invention is directed to apparatus and methods of operation that are further described in the following Brief Description of the Drawings, the Detailed Description of the Drawings, and the Claims. Other features and advantages of the present invention will become apparent from the following detailed description of the invention made with reference to the accompanying drawings.

### BRIEF DESCRIPTION OF THE SEVERAL VIEWS OF THE DRAWINGS

FIG. 1 is a system diagram illustrating an infrastructure constructed and operating according to an embodiment of the present invention;

FIG. 2 is a system diagram illustrating an infrastructure constructed and operating according to another embodiment of the present invention;

FIG. 3 is a block diagram illustrating a plurality of client telephony bridging devices and their interconnection to various telephony infrastructure components constructed and operating according to an embodiment of the present invention;

FIG. 4 is a block diagram illustrating a client telephony bridging device constructed according to a first embodiment of the present invention;

FIG. 5 is a block diagram illustrating a client telephony bridging device constructed according to a second embodiment of the present invention;

FIG. 6 is a block diagram illustrating a client telephony bridging device constructed according to a third embodiment of the present invention;

FIG. 7 is an operational flow diagram illustrating a plurality of VoIP to PSTN telephony operations according to embodiments of the present invention; and

FIG. 8 is an operational flow diagram illustrating a plurality of PSTN to VoIP telephony operations according to embodiments of the present invention.

### DETAILED DESCRIPTION OF THE INVENTION

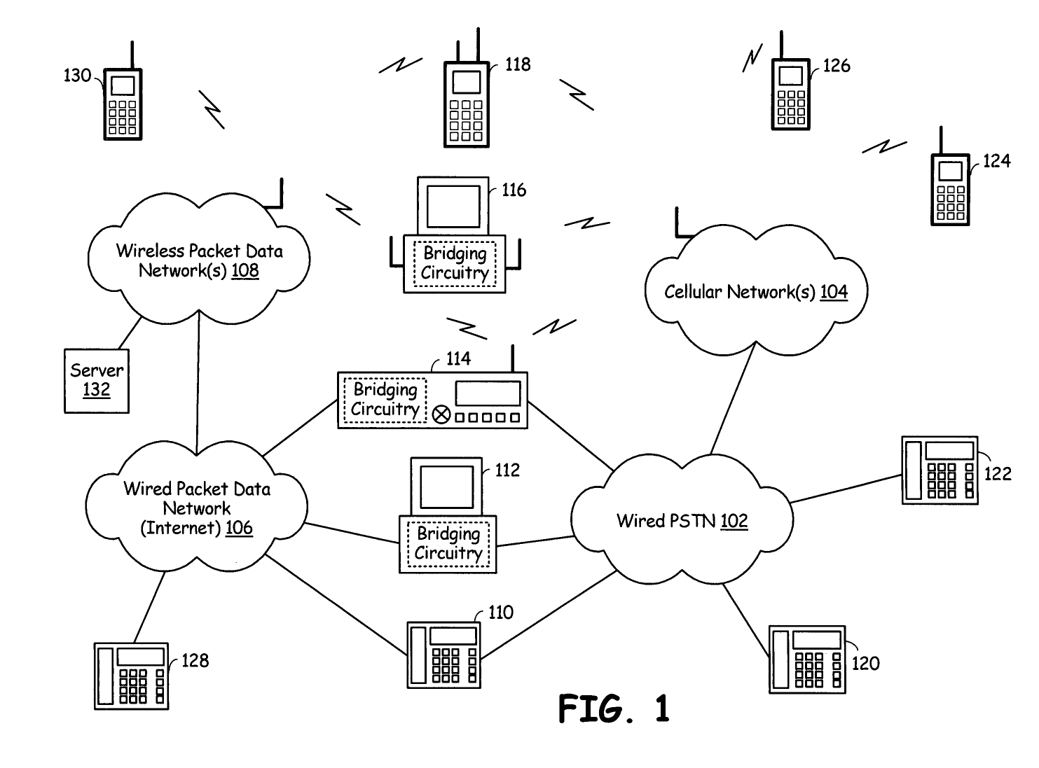

FIG. 1 is a system diagram illustrating an infrastructure constructed and operating according to an embodiment of the present invention. The infrastructure supports both Voice over Internet Protocol (VoIP) telephony via the Internet and Public Switched Telephone Network (PSTN) telephony via the PSTN. The infrastructure of FIG. 1 includes a plurality of client telephony bridging devices 110, 112, 114, 116, and 118 that communicatively couple to both the Internet and to the PSTN that are operable to bridge calls between the Internet and the PSTN. Client telephony bridging device 110 has the structure of a telephone and couples to both wired packet data network 106 and wired PSTN 102. The wired packet data network 106 includes the Internet or coupling to the Internet. The structure and operation of the wired PSTN 102 is generally known and is employed to service conventional telephony applications. The wired packet data network 106 and a wireless packet data network 108 operates in a packet-switched manner while the wired PSTN 102 (and a cellular network 104, in some embodiments) operates in a circuit-switch manner.

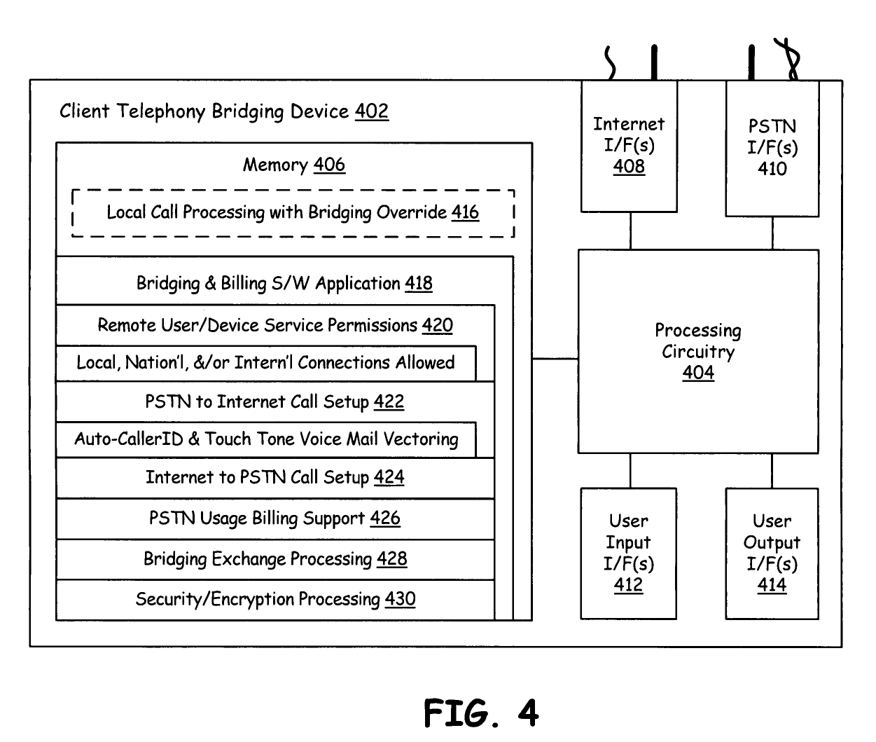

The structure of client telephony bridging device 110 will be illustrated further with reference to FIG. 4. Generally, client telephony bridging device 110 couples to the wired packet data network 106 via a wired connection such as a DSL connection, a cable modem connection, or another wired connection and couples to the wired PSTN 102 via a wired connection such as a twisted pair supporting conventional plain old telephone system (POTS) telephony, DSL, ISDN, or another conventional PSTN interface. Client telephony bridging device 110 includes bridging circuitry operable to bridge calls between the wired PSTN 102 and the wired packet data network 106.

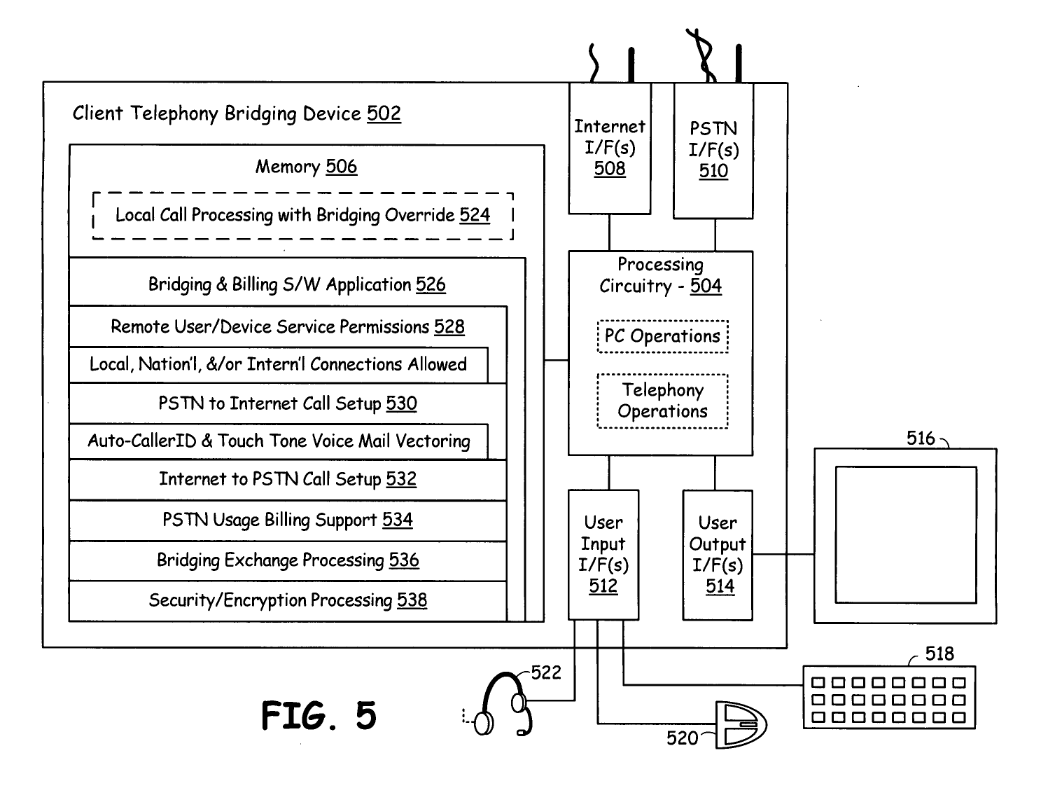

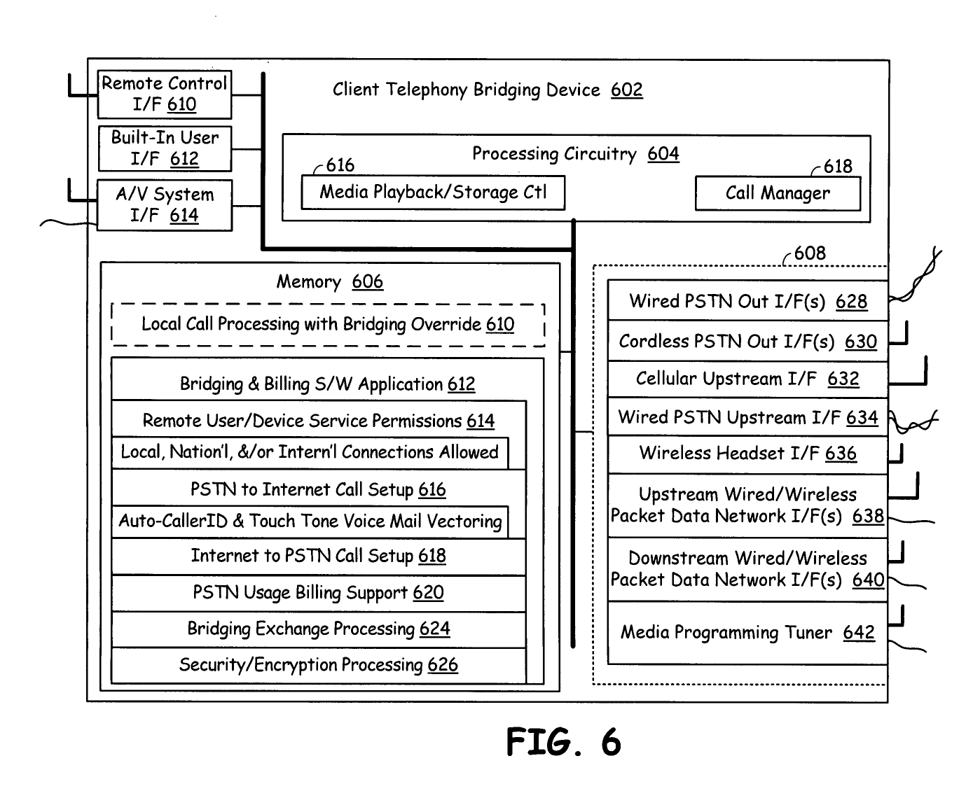

Generally, client telephony bridging device 112 has the structure of a personal computer that will be described further herein with reference to FIG. 5. Client telephony bridging device 112 couples to the wired packet data network 106 and to the wired PSTN 102 via connections same or similar as those servicing client telephony bridging device 110. Client telephony bridging device 112 includes bridging circuitry operable to bridge calls between the wired PSTN 102 and the wired packet data network 106. Client telephony bridging device 114 has the structure of a set-top box and will be described further herein with reference to FIG. 6. Generally, client telephony bridging device 114 includes bridging circuitry that is operable to bridge calls between the wired PSTN 102 and the wired packet data network 106. Further, in some embodiments, client telephony bridging device 114 may have wireless connections to wireless packet data networks 108 and/or to cellular networks 104. With this structure, client telephony bridging device 114 may also be operable to bridge calls between the cellular network(s) 104 and the wireless packet data network(s) 108.

Client telephony bridging device 116 has, generally, the structure of a personal computer and wirelessly couples to wireless packet data network(s) 108 and to cellular network(s) 104. The wireless connection between client telephony bridging device 116 and the wireless packet data network 108 may be a wireless local area network (WLAN) connection, a fixed wireless connection, a satellite network communication link, or another wireless link. The wireless connection between client telephony bridging device 116 and the cellular network 104 supports one or more cellular interface standards. Client telephony bridging device 116 is operable to bridge calls between the cellular network(s) 104 and the wireless packet data network(s) 108. The client telephony bridging device 116 communicatively couples to the Internet 106 via the wireless packet data network 108 and to the wired PSTN 102 via the cellular network(s) 104.

Client telephony bridging device 118 is operable to bridge calls between the cellular network 104 and the wireless packet data network 108. Client telephony bridging device 118 wirelessly couples to both the wireless packet data network(s) 108 and to cellular network(s) 104. The structure of client telephony bridging device 118 may be similar to that described with reference to FIG. 4.

Also shown in FIG. 1 are VoIP telephone 128, wireless VoIP telephone 130, cellular telephones 124 and 126, and PSTN telephones 120 and 122. These devices operate conventionally to service calls via their servicing networks. Server 132 supports telephony bridging operations according to the present invention.

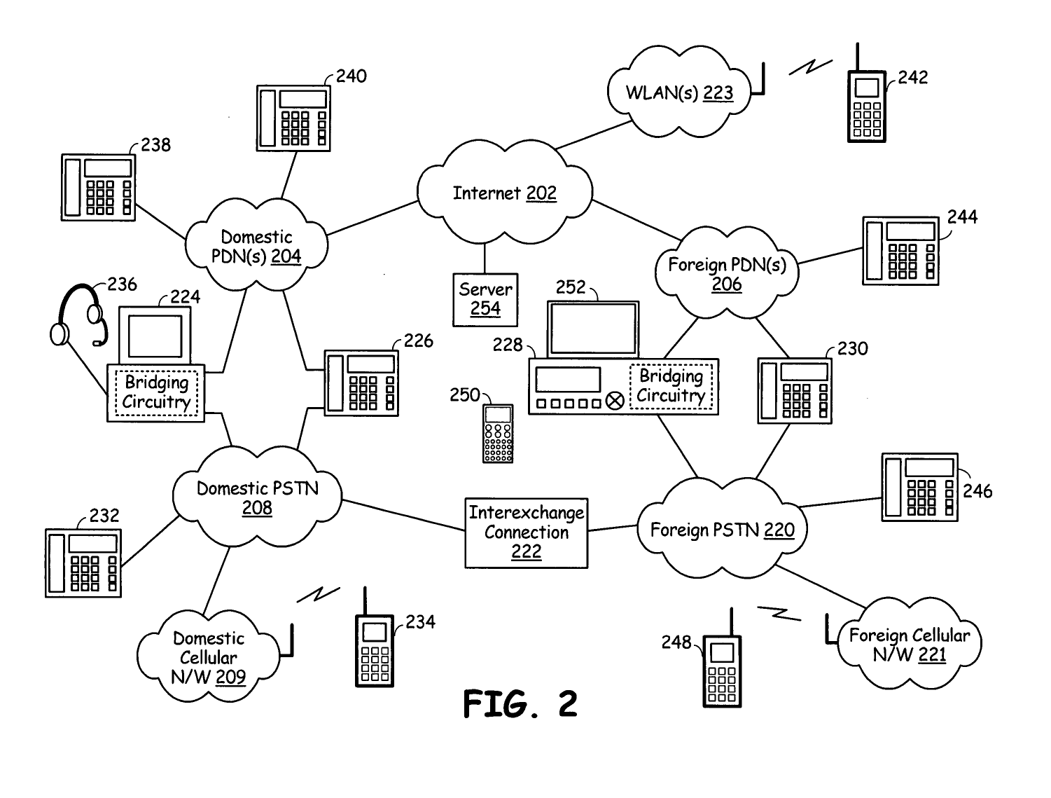

Any of the client telephony bridging devices 110-118 is operable to bridge a call between the Internet and the PSTN. Thus, any of the client telephony bridging devices 110-118 is operable to bridge a call between a VoIP terminal and a PSTN terminal, e.g.., for VoIP terminal 128 and PSTN telephone 120. Bridging according to the present invention operates without requiring use of a conventional VoIP gateway that would be deployed by a VolP telephone company, for example. Further, the plurality of client telephony bridging devices 110-118 service routing of telephone calls between a first PSTN or cellular device and another PSTN or cellular device via the Internet to reduce or minimize PSTN tolls. These operations will be described further with reference to FIG. 2.

Server processing circuitry resides within server 132 (or in another location) and enables telephony bridging according to the aspects of the present invention. The server processing circuitry communicatively couples to the plurality of client telephony bridging devices 110-118 and is operable to assist and enable the bridging of calls and to manage subscribers supported by the client telephony bridging devices 110-118. In other embodiments, the server processing circuitry may be co-located with one or more of the client telephony bridging devices 110-118 and/or may be distributed among the plurality of client telephony bridging devices 110-118.

In one of its operations, the server processing circuitry receives a voice call setup request from a calling voice terminal via the Internet 106 that identifies a subscriber. The subscriber may correspond to a particular VoIP terminal, e.g., VoIP telephone 128, or may simply be subscriber to the system. The server processing circuitry obtains access rules for the subscriber and, based upon the access rules for the subscriber and based upon access rules for the plurality of client telephony bridging devices 110-118, select a servicing telephony bridging device from the plurality of client telephony bridging devices 110-118. For example, if a subscriber using VoIP terminal 128 desires to connect a call to PSTN telephone 120, the voice call setup request would identify PSTN telephone 120 or a subscriber associated therewith. The server processing circuitry considers the characteristics of the requesting subscriber and the bridging availability of each of the plurality of client telephony bridging devices 110-118. Based upon these considerations, the server processing circuitry selects a servicing client telephony bridging device, e.g., client telephony bridging device 114, to service the telephone call. The servicing client telephony bridging device 114 then operates to bridge the call that is incoming from VolP telephone 128 between the Internet 106 and the wired PSTN 102 and to complete the call to PSTN telephone 120.

In further operations according to the present invention, the server processing circuitry monitors usage of the client telephony bridging device 114 by the serviced subscriber for record keeping purposes. In keeping records, the server processing circuitry may track bridging usage of the client telephony bridging device 114 by the subscriber. For example, each of a plurality of subscribers of the system of the present invention may each have associated therewith one or more respective client telephony bridging devices that they have agreed to allow use of by other subscribers. In exchange for allowing use of its client telephony bridging device, a subscriber is allowed to use client telephony bridging devices of other subscribers. Such shared usage may be billed on a usage basis, billed as a monthly service fee, or performed according to a bartering arrangement. Subscribers that do have associated therewith a client telephony bridging device may simply pay a monthly fee and/or a usage fee to use the client telephony bridging devices of other subscribers.

As will be further described with respect to FIG. 2, each of the plurality of client telephony bridging devices 110-118 accesses the wired PSTN 102, the cellular network(s) 104, or another telephony network at a particular location. By the server processing circuitry selecting a particular client telephony bridging device of the plurality of client telephony bridging devices 110-118 for servicing each particular bridged call, PSTN charges may be reduced or eliminated.

Each of the subscribers of the system of the present invention is subject to subscriber-based access rules. The subscriber-based access rules govern access of the subscribers to the system to the plurality of client telephony bridging devices 110-118. Each of the client telephony bridging devices 110-118 has associated therewith device-based access rules that govern respective access to the devices. Generally, the server processing circuitry governs the subscriber-based access rules while the server processing circuitry and/or respective client telephony bridging devices govern device-based access rules.

Each of the client telephony bridging devices 110-118, in addition to supporting telephony bridging, also supports a local subscriber. According to the present invention, local subscriber use of the client telephony bridging device is coordinated with the telephony bridging operations of the client telephony bridging device. For example, device-based and/or subscriber-based access rules are in effect for a local subscriber and his/her client telephony bridging device 112. According to these access rules, the local subscriber agrees to allow usage of his client telephony bridging device 112 for the bridging of calls of other subscribers. With these access rules in place and while the client telephony bridging device 112 is bridging a voice call for a non-local subscriber, the client telephony bridging device 112 receives a use request by the local subscriber. The access rules, however, provide that in exchange for the use of other client telephony bridging devices, the local subscriber has given up the right to access his client telephony bridging device 112 while it is in use bridging a call. Thus, when the client telephony bridging device 112 receives the use request by the local subscriber, instead of granting access immediately, the client telephony bridging device 112 may send a report to the server processing circuitry that a local subscriber use request has been received. The server processing circuitry then interacts with the client telephony bridging device 112 to grant delayed access or to deny access to the local subscriber.

In another operation, based upon the access rules, the server processing circuitry may initiate handover of the bridged call to a different client telephony bridging device and then allow the local subscriber access to the local client telephony bridging device 112. In another operation, the server processing circuitry may direct the client telephony bridging device 112 to provide an indication to the non-local subscriber (for which the voice call bridging service is being provided) that the voice call bridging service will be terminated. After such notice is given, the server processing circuitry would direct the client telephony bridging device 112 to terminate the bridged call and then to provide access to the local subscriber corresponding to the client telephony bridging device 112. In still another operation, the client telephony bridging device 112, based upon instructions from the server processing circuitry, may simply deny access to the local subscriber. Of course, other operations may be supported according to the present invention in granting various levels of access to the client telephony bridging device 112.

The client telephony bridging device 112 may be an emergency access button that, upon activation, grants immediate access to the local subscriber. For example, when a local subscriber would require access to a 911 link, the client telephony bridging device 110 would immediately provide access to the local subscriber. When the local subscriber required immediate access to the client telephony bridging device 110 in a non-emergency operation, a billing penalty or barter exchange system penalty may be applied to the local subscriber based his/her immediate non-emergency access.

The client telephony bridging device 110 may include a button that places the client telephony bridging device 110 in a shared mode upon activation. When in the shared mode, the client telephony bridging device 110 would be available for non-local subscriber access for call bridging operations. When not in the shared mode, the client telephony bridging device 110 would not be accessible for bridging of non-local subscribers. These operations may be recognized in the local-user's subscriber or bartering agreement.

In another operation, the local subscriber may have a first level access to the client telephony bridging device 112 while a non-local subscriber would have a second level of access to the client telephony bridging device 112. Such access may vary during time of day, day of week, week of month, and month of year for each of the plurality of client telephony bridging devices 110-118. For example, when a local subscriber of a bridging device, e.g., 110, travels, the local subscriber may press a button or enter a code into the client telephony bridging device 110 to indicate that he will be traveling. Based upon this input, the server processing circuitry understands that local use of the client telephony bridging device 110 is not required for a period and more liberally allows the client telephony bridging device 110 to be used for call bridging by non-local subscribers.

In another operation according to the present invention, the access rules may change based upon a particular subscriber's usage of one or more non-local client telephony bridging devices. For example, in a barter use system or another usage based system, when a subscriber's use of non-local client telephony bridging devices exceeds a threshold over a given period, the subscriber may be precluded from further use during a relevant period, be additionally billed for the heavy use, or be provided reduced access to the system. At this point, the subscriber could opt to pay additional fees for additional use or simply accept limited accessibility to the client telephony bridging devices of other subscribers.

FIG. 2 is a system diagram illustrating an infrastructure constructed and operating according to another embodiment of the present invention. The infrastructure includes a plurality of client telephony bridging devices 224, 226, 227, and 220, the Internet 202, domestic packet data network(s) 204, foreign packet data network(s) 206, a domestic PSTN 208, a domestic cellular network 209, a foreign PSTN 220, and a foreign cellular network 221. With the embodiment of FIG. 2, domestic PSTN 208, domestic packet data network(s) 204, and domestic cellular network 209 reside within one geographic locale, e.g., the United States, a portion of the United States, or a portion of a state of the United States. Likewise, the foreign packet data network(s) 206, foreign PSTN 220, and foreign cellular network 221 reside within a differing locale. Such differing locale may be a European country, an Asian country, a South American country, or another locale that differs from the domestic locale. The Internet 202 is an international network that communicatively couples between domestic packet data network(s) 204 and foreign packet data network(s) 206. Coupled to the Internet 202 are one or more WLANs 223 and/or other wireless packet data networks.

Domestic cellular network 209 communicatively couples to domestic PSTN 208 and services cellular handset 234. In another structure according to the present invention, the cellular network 209 couples directly to the domestic packet data network(s) and/or the Internet 202. Domestic PSTN 208 services PSTN telephone 232 and couples to client telephony bridging devices 224 and 226. Domestic packet data network 204 services VoIP telephones 238 and 240 and couples to client telephony bridging devices 224 and 226. Foreign PSTN 220 services PSTN telephone 246 and couples to client telephony bridging devices 228 and 230. The foreign cellular network 221 services cellular telephone 248 and communicatively couples to the foreign PSTN 220. In an alternate construct, the foreign PSTN 220 couples directly to the foreign packet data network(s) 206 and/or to the Internet 202. The foreign packet data network 206 services VoIP telephone 244 and couples to both client telephony bridging device 228 and to client telephony bridging device 230. WLAN(s) 223 service VoIP terminal 242.

Interexchange connection 222 intercouples domestic PSTN 208 with foreign PSTN 220 and routes PSTN telephone calls between the domestic PSTN 208 and the foreign PSTN 220 according to conventional operations. With a conventional PSTN telephone operation, PSTN telephone 232 desires to establish a call with PSTN telephone 246. In doing so, the user of PSTN telephone 232 enters an unique PSTN telephone number corresponding to PSTN telephone 246. Domestic PSTN 208, interexchange connection 222, and foreign PSTN 220, in combination, service the PSTN call between the PSTN telephone 232 and 246. With this conventional operation, both the domestic PSTN 208 and the foreign PSTN 220 charge one or more accounts corresponding to the PSTN telephones 232 and 246 for establishing and servicing the telephone call. Such charges may be excessive and preclude communication between domestic and foreign users.

According to the infrastructure of the present invention, the plurality of client telephony bridging devices 224, 226, 228, and 230 service voice and multimedia calls in a manner that differs from prior systems. In one example of operation of the system of the present invention, a user of PSTN telephone 232 desires to establish a call to PSTN telephone 246. In performing this operation, user of PSTN telephone 232 communicatively couples with client telephony bridging device 224, for example, via the domestic PSTN 208. The user of PSTN telephone 232 then interacts with the client telephony bridging device 224 via touch pad operations, a voice recognition system, voice mail vectoring operations, or other means to indicate that it desires to establish a call with PSTN telephone 246. Client telephony bridging device 224 then either interacts with server 254 or interacts directly with client telephony bridging device 228 or 230 via the domestic packet data network(s) 204, the Internet 202, and the foreign packet data network(s), which couples to foreign PSTN 220.

Client telephony bridging device 224, in interacting with client telephony bridging device 230, establishes permission for use of client telephony bridging device 230 and provides sufficient information to enable client telephony bridging device 230 to establish a PSTN telephone call with PSTN telephone 246. With the connection setup, client telephony bridging device 230 establishes a call path to PSTN terminal 246. Client telephony bridging devices 224 and 230 establish a complete routing path between PSTN telephone 232 and PSTN telephone 246 that includes the domestic PSTN 208, client telephony bridging device 224, domestic PDN 204, the Internet 202, foreign packet data network 206, client telephony bridging device 230, and foreign PSTN 220 to service the call between a user of PSTN telephone 232 and a user of PSTN telephone 246. Because the telephone call is established and serviced other than via the interexchange connection 220, significant PSTN toll charges are reduced or alleviated to service the call.

In a somewhat similar operation, a user of VoIP telephone 244 desires to establish a call with cellular telephone 234. With conventional operations, use of the interexchange connection 222 would be required. According to the present invention, this call is serviced via VoIP telephone 244, foreign packet data network(s) 206, the Internet 202, domestic packet data network(s) 204, client telephony bridging device 226, domestic PSTN 208, cellular network 209, and cellular telephone 234. The call is setup initially via interaction between VoIP telephone 244 and client telephony bridging device 226, which completes the connection to cellular telephone 234. Then, during the call, client telephony bridging device 226 bridges the call between domestic packet data network(s) 204 and domestic PSTN 208.

Likewise, VoIP telephone 238 or 240 may establish a call with cellular telephone 248 via domestic packet data network(s) 204, Internet 202, foreign packet data network(s) 206, one of client telephony bridging devices 228 and 230, foreign PSTN 220, and foreign cellular network 221. Routing the call in this fashion reduces significantly in the cost of PSTN toll charges. These operations could also be supported among any terminal pair illustrated in the system of FIG. 2.

According to another operation of the present invention, a client telephony bridging device 224 is bridging a call for PSTN terminal 246 and PSTN terminal 232 to reduce their PSTN toll charges. The communication path for such servicing may include foreign PSTN 220, client telephony bridging device 230, foreign packet data network(s) 206, the Internet 202, domestic packet data network(s) 204, client telephony bridging device 224, and the domestic PSTN 208. Then, a local subscriber of the client telephony bridging device 224, using user interface 236, desires to use the client telephony bridging device 224 to place a call. At this time, action must be taken with regard to the local subscriber. In a first operation, client telephony bridging device 224 simply ceases bridging of the call between PSTN terminal 246 and PSTN terminal 232. In a second operation, the client telephony bridging device 224 gives notice of impending termination of the bridged call and then terminates bridging. In a third operation, the client telephony bridging device 224 decides that it will deny access to the local subscriber. In making this determination, the client telephony bridging device 224 may access server 254 to obtain access rules relating to the subscriber and/or the client telephony bridging device 224.

Prior to terminating a bridged call, the client telephony bridging device 224 may establish another path for the bridged call for servicing via another client telephony bridging device, e.g., client telephony bridging device 226. The newly established communication path including client telephony bridging device 226 would then service the call between PSTN terminal 246 and PSTN terminal 232. In taking over the bridging operations, the client telephony bridging devices 224 and 226 may first establish a three-way call with PSTN terminal 232 via the domestic PSTN 209. Then, client telephony bridging device 224 may simply drop the call. The client telephony bridging device must also receive VoIP packets via the domestic packet data network(s) 204 that support the bridged call. Receipt of VoIP packets may simply be accomplished by redirecting the VoIP packets transmitted by client telephony bridging device 230. While transitioning from client telephony bridging device 224 to client telephony bridging device, VoIP packets may be multicast from client telephony bridging device 230 to both client telephony bridging device 224 and client telephony bridging device 226.

According to the present invention, owners/local users/local subscribers of the client telephony bridging devices 224, 226, 228, and 230 share their devices with subscribers or local owners of other client telephony bridging devices. Such sharing may be under a bartering system or a subscriber agreement. With this shared system of the present invention, the system need not have VoIP gateways deployed at local PSTN connection points. Such is the case because the client telephony bridging devices 224-230 serve the purpose of the gateways without requiring particular deployments.

Thus, for example, if a individual purchases a device such as a set-top box 228 that supports client telephony bridging operations, the user may simply use the set-top box 228 to service a high definition television monitor 252 and remote control 250 to watch received programming. However, the user may determine that it would be advantageous to become a subscriber to the system of the present invention to gain the benefits of access to other client telephony bridging devices. In such case, the owner of set-top box 228 (client telephony bridging device) would setup the device as a client telephony bridging device. Then, based upon a subscription level of the user, or user preferences, the set-top box 228 (client telephony bridging device) would service call bridging for non-local subscribers. For example, the local subscriber corresponding to client telephony bridging device 228, having given access to non-local subscribers to client telephony bridging device 228, in exchange gains access to non-local client telephony bridging devices 226, 228, and 230. The local subscriber corresponding to client telephony bridging device 228 could access the foreign PSTN 220 without an access charge or PSTN toll fees in some cases.

The manner in which the plurality of subscribers corresponding to the plurality of client telephony bridging devices 224-230 exchange services may be in a bartering system. In such case, each of the client telephony bridging devices either alone or in communication with server 254 monitors its usage by non-local subscribers. Based upon this usage level, the local subscriber would have access to non-local client telephony bridging devices for his or her own bridging operations. For example, a caller residing in Prague, Czech Republic would like to place a call to California. The caller in Prague has an Internet phone that is attached wirelessly to the Internet 202, e.g., via wireless LAN 223 and VoIP terminal 242. Upon attachment to the wireless LAN 223, the VoIP terminal 242 accesses server 254 which responds with one or several recently registered client telephony bridging devices 224 and 226 that are able to offer gateway service in the desired (949) 321 central office area. In one operation the server 254 provides the IP addresses of the available client telephony bridging devices 224 and 226 and also their associated domestic PSTN 208 access point information, e.g., (949) 321. Then, the VoIP terminal 242, via wireless LAN 223, Internet 202 and domestic PDN 204 interacts with either client telephony bridging device 224 or 226 to access PSTN telephone 232 or cellular terminal 234. If one of the client telephony bridging devices 224 or 226 can service the call, then the caller at VoIP terminal 242 establishes the telephone call to PSTN telephone 232 or cellular terminal 234 with little or no PSTN toll charges. During dependency of the call, the client telephony bridging device, e.g., 226, acting as a gateway for the call identifies or tracks the usage by VoIP telephone 242. Later, the usage will be used in determining what access or perhaps what charge to be incurred to the subscriber respective to VoIP telephone 242.

The system of the present invention could use an annual subscription basis, a usage basis, a combination of usage and annual fee, or simply an annual fee plus a barter type arrangement. When a bartering system is established, each local subscriber may be required to allow a certain number of minutes of access to his/her respective client telephony bridging device or devices. In return, the subscriber may receive a like number of minutes of bridged telephone calls. However, many variations could exist in this bartering arrangement, examples being if a subscriber pays a larger fee, he could use other non-local client telephony bridging devices more than he allows usage of his local client telephony bridging device. According to another aspect to the present invention, a client telephony bridging device such as client telephony bridging device 224 may support 3-way bridging. With such 3-way bridging, the client telephony bridging device 236 could establish a call conference between one or more VoIP telephones, e.g., 238 and 240, and one or more PSTN telephones 232 and 234, for example. The client telephony bridging device 224 support such operations because they couple both to the domestic PSTN 208 and domestic packet data network and include circuitry therein for performing such bridging and conferencing activities.

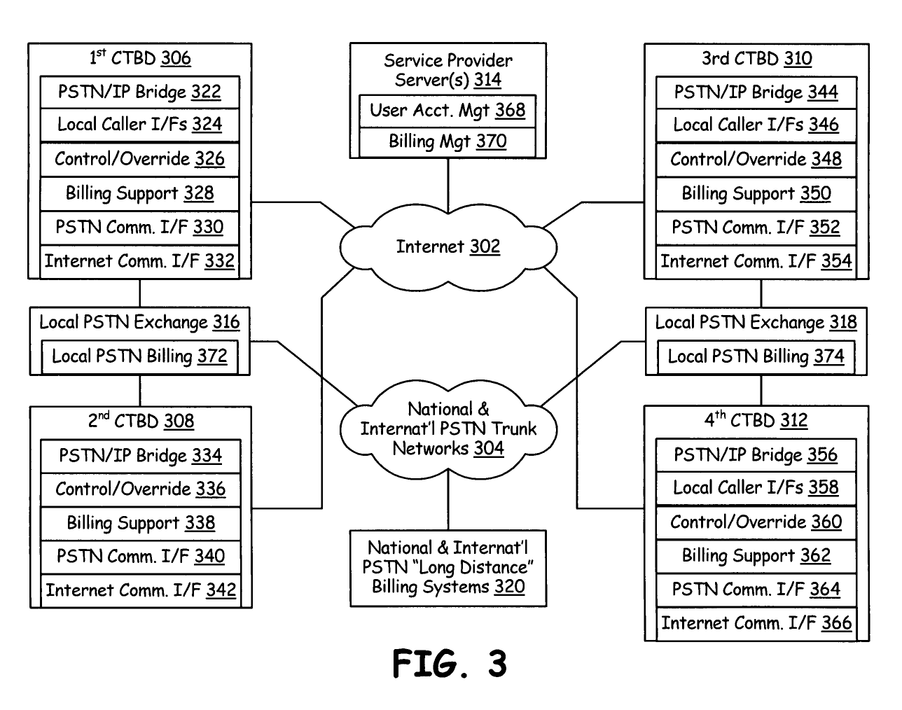

FIG. 3 is a block diagram illustrating a plurality of client telephony bridging devices and their interconnection to various telephony infrastructure components constructed and operating according to an embodiment of the present invention. Shown are client telephony bridging devices 306, 308, 310, and 312. The structure of the client telephony bridging devices 306-312 illustrated in FIG. 3 include generally functional components that are employed with operations of the present invention. These functional components may be embodied in hardware components, software components, or a combination of hardware components and software components. The client telephony bridging devices may include additional components that are not illustrated in FIG. 3.

As shown, each of the plurality of client telephony bridging devices 306-312 couples to the Internet 302. Further, first client telephony bridging device 306 and second client telephony bridging device 308 couple to local PSTN exchange 316. Third client telephony bridging device 310 and fourth client telephony bridging device 312 couple to local PSTN exchange 318. Each of the local PSTN exchanges 316 and 318 communicatively couple to national and international PSTN trunk networks 304.

Coupled to the Internet 302 also is one or more service provider servers 314 that may operate according to the present invention in conjunction with the client telephony bridging devices 306-312. Further, coupled to the national and international PSTN trunk networks 304 are one or more national and international PSTN long distance billing systems 320.

Referring now to the first client telephony bridging device 306, the client telephony bridging device 306 includes a PSTN communication interface 330 that communicatively couples the client telephony bridging device 306 to the local PSTN exchange 316. Further, the client telephony bridging device 306 includes Internet communication interface 332 that communicatively couples the client telephony bridging device 306 to the Internet 302. The first client telephony bridging device 306 includes one or more local caller interfaces 324 that service one or more local users of the client telephony bridging device 306. The local caller interface(s) 324 may service wireless handsets, wired handsets, headsets, or other devices that allow a local subscriber to place and receive calls via the client telephony bridging device 306.

According to the present invention, the client telephony bridging device 306 includes PSTN to VoIP bridging functionality 322. As was previously described with reference to FIGS. 1 and 2, the client telephony bridging device 306 is operable to bridge calls between the PSTN 316 and the Internet 302. In such case, with the particular structure of FIG. 3, client telephony bridging device 306 is operable to enact the PSTN/IP bridge functionality 322 to bridge calls between the national and international PSTN trunk networks 302 and the Internet 302 via local PSTN exchange 316 and PSTN communication interface 330 and Internet communication interface 332.

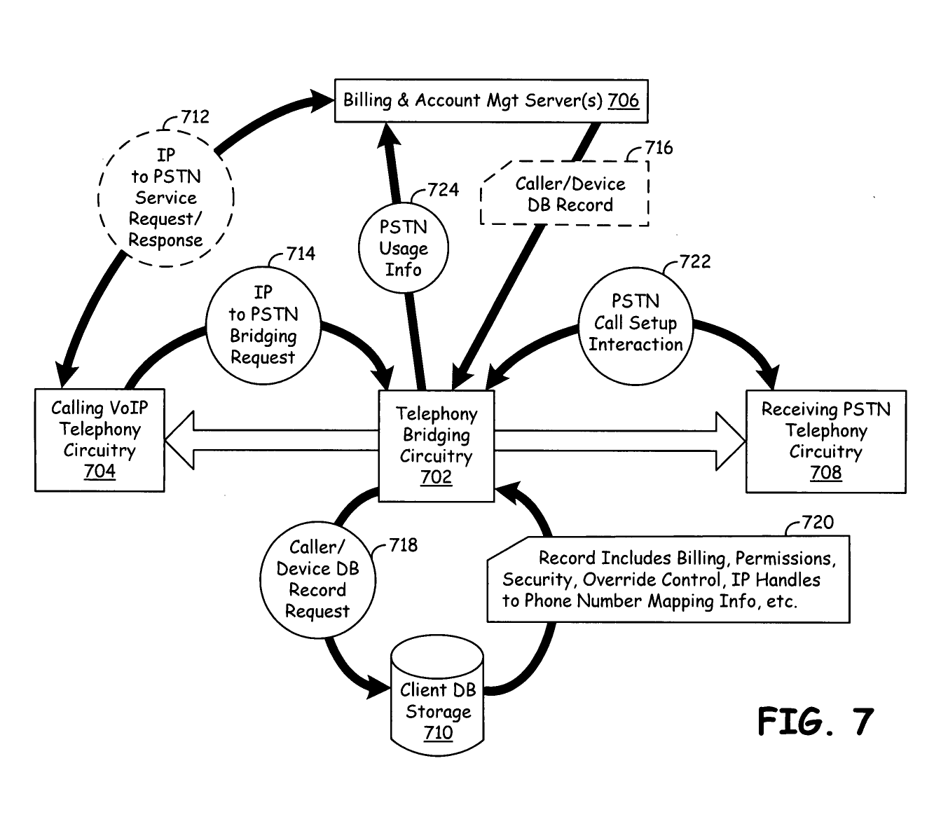

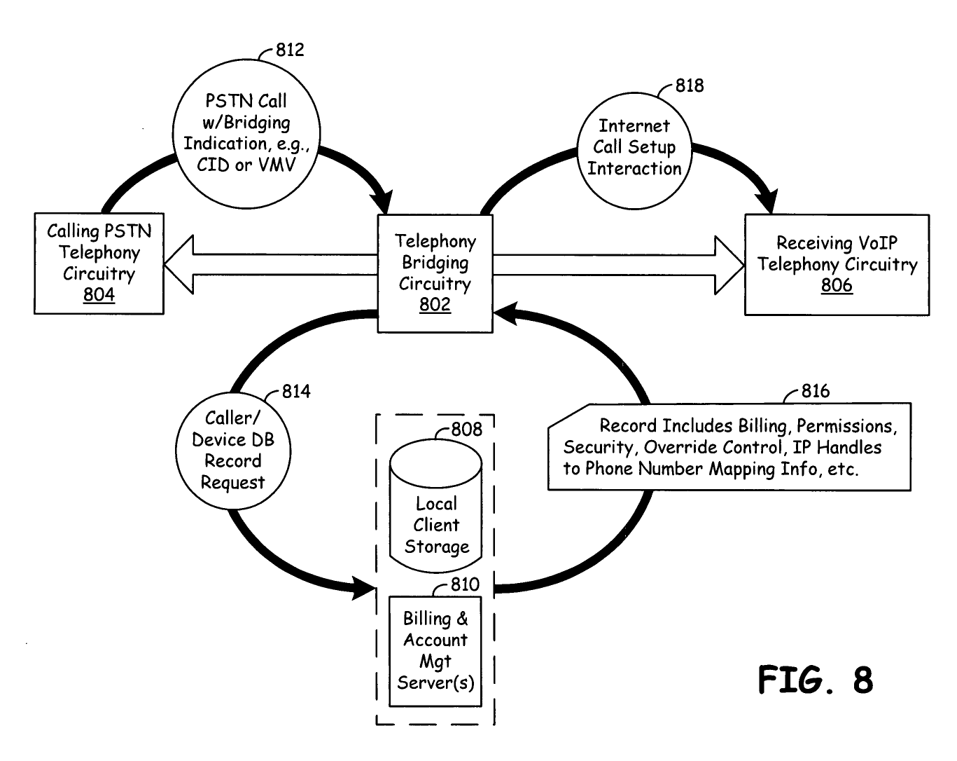

With the operations of the present invention, the client telephony bridging device 306 includes control and override functionality 326. Such control and override functionality 326 allows a local subscriber/user of the device 306 to enable or disable bridging functionality, enable or disable local caller use, and to provide other control and override functionality. Billing support functionality 328 of the client telephony bridging device 306 supports interactions between the client telephony bridging device and billing management software running on service provider servers 314 and/or with the national and international PSTN long distance billing systems 320. The operations supported by the billing support 328 will be described further with reference to FIGS. 7 and 8.

The second, third, and fourth client telephony bridging devices 308, 310, and 312, include similar functional components. For example, the second client telephony bridging device 308 includes PSTN/IP bridging functionality 334, control/override functionality 336, billing support functionality 338, a PSTN communication interface 340, and an Internet communication interface 342. Note that client telephony bridging device 308 does not include a local call interface 324. Such may be the case with a set-top box, for example, that does not serve primarily as a voice of multimedia communications device for a local subscriber.

Likewise, the third client telephony bridging device 310 includes PSTN/IP bridging functionality 344, local call interface(s) 346, control/override functionality 348, billing support functionality 350, a PSTN communication interface 352, and an Internet communication interface 354. The fourth client telephony bridging device 312 includes PSTN/IP bridging functionality 356, one or more local caller interfaces 358, control/override functionality 360, billing support functionality 362, a PSTN communication interface 364, and an Internet communication interface 366.

According to some aspects of the present invention, the client telephony bridging devices 306-312 are employed in order to eliminate or minimize PSTN toll charges for serviced subscribers. The system of the present invention may have its own subscriber usage and/or billing functions. As was previously described, a bartering system or a subscription service may be employed for users of the client telephony bridging devices 306-312. In such case, the billing support functionality of the client telephony bridging devices 306-312 may interact with billing management functionality 370 of the service provider server(s) 314. Further, in determining how subscribers may access any of the client telephony bridging devices 306-312, the user account management functionality 326 of the service provider server 314 is enacted in conjunction with control functionality of the client telephony bridging devices.

Each of the local PSTN exchanges 316 and 318 includes local PSTN billing functionality 372 and 374, respectively. This local PSTN billing functionality 372 and 374 causes an accessing client telephony bridging device to pay PSTN access and use fees in some cases. According to the present invention, some of these usage fees or access fees may be accounted for by the billing management functionality 370 of the service provider server 314 to allocate such costs to particular subscribers of the system of the present invention.

FIG. 4 is a block diagram illustrating a client telephony bridging device constructed according to a first embodiment of the present invention. The structure of client telephony bridging device 402 may correspond to bridging telephones 110, 226, 230, or to another client telephony bridging device of the present invention. The client telephony bridging device 402 includes processing circuitry 404 that may be a microprocessor, digital signal processor, a combination of various processors, one or more application specific integrated circuits, or another type of processing device operable to execute software instructions or to perform hard-wired operations. Client telephony bridging device 402 also includes memory, one or more Internet interface(s) 408, one or more PSTN interface(s) 410, user input interface(s) 412, and user output interface(s) 414.

The memory 406 is operable to store software instructions that, when executed by the processing circuitry 404, enables operation according to embodiments of the present invention. Internet interface(s) 408 communicatively couple the client telephony bridging device 402 to the Internet via wired or wireless means. For example, when the Internet interface 408 supports a wired connection, it may support a local area network connection, a DSL connection, an ISDN connection, a cable modem connection, a fiber optic connection, or another wired Internet connection supporting packet data communications. When the Internet interface 408 supports wireless connections it may support WLAN connectivity, a fixed wireless connection, a satellite cable modem interface connection, or another wireless connection such as a cellular connection. The PSTN interface(s) 410 communicatively couple the client telephony bridging device 402 to the PSTN via wired or wireless means. For example, the PSTN interface(s) 410 may include a wired connection that couples the client telephony bridging device 402 to a central office via twisted copper pair of wires. However, the PSTN interface may also support a wireless connection to a cellular network or to a central office for example. The user input interface 410 communicatively couples the client telephony bridging device 402 to user input devices such as keypads, microphones, mice, or other user input devices. User output interface(s) 414 communicatively couple the client telephony bridging device 402 to a user output device such as speakers, a monitor, or another output device.

The memory stores software instructions that, when executed by processing circuitry 404, cause the client telephony bridging device 402 to operate according to the present invention. Generally, these software instructions support functionality relating to local call processing with bridging override operations 416, bridging and billing software application operations 418, PSTN to Internet call setup operations 422, Internet to PSTN call setup operations 424, PSTN usage billing support operations 426, bridging exchange processing operations 428, and security/encryption processing operations 430. Referring particularly to the local call processing with bridging override instructions 416, upon execution, the processing circuitry 404 enables the client telephony bridging device 402 to locally process calls to override bridging operations of the client telephony bridging device 402. In its normal operations, the client telephony bridging device 402 is available to bridge calls between its Internet interface(s) 408 and its PSTN interface(s) 410. However, during such bridging operations, a local subscriber may desire to access the PSTN or the Internet via user input and output interface(s) 412 and 414 that would interrupt or compromise the currently bridged call. The local call processing with bridging override functionality 416 establishes rules that allow the user to access and disrupt a currently bridged call or not depending upon the particular rules established. With the particular operation, a local subscriber may always interrupt a currently bridged call, sometimes interrupt a currently bridged call, or never interrupt a currently bridged call. The ability of a local subscriber/user to interrupt a locally bridged call may be based upon access rules that are obtained from a remote location or locally stored.

The bridging and billing software application 418 encompasses each of remote user/device service permissions 420, the PSTN to Internet call setup operations 422, the Internet to PSTN call setup operations 424, the PSTN usage billing support operations 426, the bridging exchange processing operations 428, and the security/encryption processing operations 430. In particular, the remote user/device service permissions operations 420 allow the client telephony bridging device 402 to determine whether a remote user or a remote device may use the client telephony bridging device 402 for call bridging operations. In such case, when bridging is allowed, these operations 420 allow local, national, and international connections. In other cases, a subset of local, national, and international connections allowed are none of the above, depending upon the permissions of the remote user or remote device.

The PSTN to Internet call setup operations 422 support another PSTN device coupled to the client telephony bridging device 402 to setup an Internet call from a calling PSTN terminal. In such case, the PSTN to Internet call setup functions 422 provide audio caller ID functions, touch tone voice mail vectoring operations, or other interface operations that allow a user of a remote PSTN telephone to interact with the client telephony bridging device 402. Based upon the communications supported by the PSTN to Internet call setup functionality 422, the remote PSTN user may setup the client telephony bridging device 402 for call bridging operations.

The Internet to PSTN call setup operations 424 allow a remote VoIP terminal itself to setup call bridging by the client telephony bridging device 402. This functionality may be via a web page interface, a simpler data communication interface that causes exchanges sufficient information to enable the Internet to PSTN call setup to occur, or via another interface.

The PSTN usage and billing support operations 426 allow the client telephony bridging device 402 to determine PSTN usage by a non-local subscriber for future billing operations. The PSTN usage billing support operations 426 may interface the client telephony bridging device 402 with the billing management software of a service provider server 314. For example, if the client telephony bridging device 402 performs call bridging for a remote VoIP or PSTN terminal, the call may be bridged not only to a local PSTN telephone but to a non-local PSTN telephone wherein additional PSTN tolls are incurred. Any usage of the PSTN while servicing a bridged telephone call may result in PSTN billing to the client telephony bridging device 402. The PSTN usage billing support functionality 426 supports capturing of such PSTN usage by the client telephony bridging device 402 and subsequent interaction with a server or with another device to cause PSTN usage billing to the appropriate remote subscriber or terminal.

The bridging exchange processing functionality 428 causes the client telephony bridging device 402 to track usage of remote subscribers for call bridging operations and to track usage of a local subscriber of remote client telephony bridging devices. This functionality may operation in conjunction with a bartering system that tracks usage of various subscribers to the bartering system. In such case, these operations may ensure that usage of client telephony bridging devices by differing subscribers is equitable. If the operations are not equitable, the bridging exchange processing operations may cause notification or bills to be sent to a subscriber that uses more than an equitable amount or number of call bridging operations.

The security/encryption processing operations 430 of the client telephony bridging device are enacted to: (1) preclude a local user from listening in on bridged calls, and (2) to preclude remote users from listening on communications of a local user of the client telephony bridging device 402. Security/encryption processing operations 430 may actually mask or encrypt data communications to preclude either the processing circuitry or the user input/output interface(s) 412 or 414 from eavesdropping on communications that are bridged.

FIG. 5 is a block diagram illustrating a client telephony bridging device constructed according to a second embodiment of the present invention. The client telephony bridging device 502 that may serve as client telephony bridging device 112 or 116, for example. The client telephony bridging device 502 includes processing circuitry 504, memory 506, PSTN interface(s) 510, Internet interface(s) 508, user input interface(s) 512, and user output interface(s) 514. The Internet interface(s) 508 couple the client telephony bridging device 502 to the Internet via an ISP, or other packet data connections in a wired or wireless fashion. The PSTN interface(s) 510 couple to client telephony bridging device 502 to the PSTN via a wired and/or a wireless connection. User input interface(s) 512 may service a mouse 520, a keyboard 518, the headset 522, or another user input interface device. User output interface 514 services a monitor 516, for example. The processing circuitry 504 includes one or more microprocessors, digital signal processors, applications specific integrated circuits, field programmable gate arrays, or other circuitry capable of processing software and/or firmware instructions and operating upon data. Generally, the processing circuitry 504 performs personal computer operations and telephony operations.

Memory 506 stores software instructions to enable the operation of the client telephony bridging device 502 according to the present invention. In its operations, the processing circuitry 504 of the client telephony bridging device 502 executes software relating to local call processing and bridging override operations 524, bridging and billing software application operations 526, remote user/device service permission operations 528, and PSTN to Internet call setup operations 530. When executing the remote user/device service permissions operations 528, the client telephony bridging device 502 determines whether local, national, and/or international connections are allowed for bridging. In its PSTN to Internet call setup operations 530, the client telephony bridging device 502 is operable to interface with a local PSTN device to perform auto-caller ID, touch tone voicemail vectoring operations, and other operations enabling a remote user of the PSTN terminal to interact to the client telephony bridging device 502 via the PSTN interface(s) 510. With these operations, the client telephony bridging device 502 supports the remote enablement of the client telephony bridging device 502 for bridging a PSTN to PSTN or PSTN to VoIP call.

Further, stored in memory 506 are software instructions that enable the client telephony bridging device 502 upon their execution to perform Internet to PSTN call setup operations 532 to PSTN usage billing support operations 534, bridging exchange processing operations 536, and security/encryption processing operations 538. These operations have been previously described with reference to FIG. 4.

FIG. 6 is a block diagram illustrating a client telephony bridging device constructed according to a third embodiment of the present invention. The client telephony bridging device 602 may serve as the set top box 114 of FIG. 1 or set top box 228 of FIG. 2, for example. The client telephony bridging device 602 includes processing circuitry 604, memory 606, communication interface 608, remote control interface 610, built-in user interface 612, and audio/visual system interface 614. The processing circuitry 604 is operable to perform media playback and storage control operations 616 and to perform call manager operations 618 according to the present invention.

The communication interface 606 includes a wired PSTN out interface 628 that services a downstream PSTN telephone, for example. A cordless PSTN out interface 630 services a cordless handset or other cordless voice communication device that may be serviced by the client telephony bridging device 602. A cellular upstream interface 632 communicatively couples the client telephony bridging device 602 to a cellular network. Wired PSTN upstream interface 634 communicatively couples the client telephony bridging device 602 to a wired PSTN. Wireless headset interface 636 communicatively couples the client telephony bridging device 602 to a wireless headset. Upstream wired/wireless packet data network interface(s) 638 communicatively couples the client telephony bridging device 602 to a wired and/or wireless packet data network. Downstream wired/wireless packet data network interface(s) 640 communicatively couple to client telephony bridging device 602 to a downstream packet data communication network such as a local area network or a wireless local area network. A media programming tuner 642 communicatively couples the client telephony bridging device 602 to a media source provider or media source network. The media programming tuner 642 receives media content via cable modem network, a satellite network, a fixed wireless network, or another network employed by a media contents provider.

Remote control interface 610 allows a user to access the client telephony bridging device 602 via remote control, e.g., remote control 250 of FIG. 2. Built-in user interface(s) 612 may be a keypad, a display, or another interface that allows a user directly to interface the client telephony bridging device 602. The audio/visual system interface 614 communicatively couples the client telephony bridging device 602 to an audio/visual system such as a home entertainment system. The home entertainment system may include a surround sound system and a high definition monitor, e.g., 252 of FIG. 2.

The memory 606 stores software instructions that, upon execution by the processing circuitry 604, enable operation according to the present invention. The software instructions include local call processing with bridging override software instructions 610, bridging and billing software application instructions 612, remote user/device service permissions software instructions 614, and PSTN to Internet call setup software instructions 616. Further, the memory 606 may also store Internet to PSTN call setup instructions 618, PSTN usage billing support software instructions 620, bridging exchange processing and software instructions 624, and security/encryption processing instructions 626. As is indicated by the names of the software instructions stored in memory 606, upon execution of these software instructions by the processing circuitry 604, the client telephony bridging device 602 performs operations according to the present invention that are previously described and that will be further described with reference to FIGS. 7 and 8.

FIG. 7 is an operational flow diagram illustrating a plurality of VolP to PSTN telephony operations according to embodiments of the present invention. The operations of FIG. 7 relate to a VoIP to PSTN telephone call. In such case, calling VoIP telephony circuitry 704 desires to establish a phone call with receiving PSTN telephony circuitry 708. With the operations of FIG. 7, the telephony bridging circuitry 702 of a client telephony bridging device of the present invention bridges the call between the calling VoIP telephony circuitry 704 and the receiving PSTN telephony circuitry 708.

In a first operation, the calling VoIP telephony circuitry 704, knowing the PSTN number of the receiving PSTN telephony circuitry 708, sends a VoIP to PSTN service request 712 to billing and account management server 706. The request sent from the calling VoIP telephony circuitry 704 to the billing and account management server 706 may include the IP address of the calling VoIP telephony circuitry 704, a handle of a calling subscriber, a handle of the receiving subscriber (of receiving PSTN telephony circuitry 708), the PSTN telephone number of receiving PSTN telephony circuitry 708, and/or other information. In response, also at 712, the billing and account management service 706 provides the calling VoIP telephony circuitry 704 with information regarding the telephony bridging circuitry 702, e.g., the IP address of telephony bridging circuitry 702, and additional information that would allow the calling VoIP telephony circuitry 704 to access the telephony bridging circuitry 702. In an alternate operation, the calling VoIP telephony circuitry 704 accesses the telephony bridging circuitry 702 directly without requiring interface to the billing and account management server 706.

Next, the calling VoIP telephony circuitry 704 sends a VoIP to PSTN bridging request 714 to the telephony bridging circuitry 702. Interaction may occur between the calling VoIP telephony circuitry and the telephony bridging circuitry 702 to elicit additional information that will be employed to establish the bridged call. Such information may identify a calling subscriber, a handle/ID of a called party, and/or or other information. In response to the VoIP to PSTN bridging request 714, the telephony bridging circuitry 702 may send a caller/device database record request 718 to client database storage 710. This record caller/device database record request 718 may provide additional information regarding not only the calling VoIP telephony circuitry 704 but the receiving PSTN telephony circuitry 708. A response from the client database storage 710 to the telephony bridging circuitry 702 includes billing information, permissions information, security information, override control information, VoIP handles to phone number mapping formation, and additional information 720. For example, when the calling VoIP telephony circuitry 704 sends the handle of a user of receiving PSTN telephony circuitry 708, the response 720 from the client database storage 710 would provide a PSTN number map to the receiving PSTN telephony circuitry 708. Further, the record 720 may provide information to telephony bridging circuitry 708 relating to the security level requirement for the serviced bridge call, whether a local user of telephony bridging circuitry 702 may override bridging for the call during the call, and additional information relating to how the telephony bridging circuitry 702 must treat the bridged call during servicing.

Next, the telephony bridging circuitry 702 performs PSTN call setup interaction 722 with the receiving PSTN telephony circuitry 708. Such PSTN call setup interaction 722 may simply be initiating a PSTN call to receiving PSTN telephony circuitry 708. Alternately, the PSTN call setup interaction 722 may cause the telephony bridging circuitry 702to interact with the receiving PSTN telephony circuitry 708 to determine whether the receiving PSTN telephony circuitry 708 will accept the bridged call. This interaction 722 may include a handle or IP address associated with the calling VoIP telephony circuitry 704. Based upon this information, the receiving PSTN telephony circuitry 708 may terminate the PSTN call, reject the PSTN call, or ask for additional information.

Once the telephony bridging circuitry 702 establishes the call to the receiving PSTN telephony circuitry 708, the call is bridged and completed between the calling VoIP telephony circuitry 704 and the receiving PSTN telephony circuitry 708. As was previously described with reference to FIGS. 1 and 2, the call will be serviced via the Internet, other packet data network(s), and at least one PSTN network. The telephony bridging circuitry 702 then monitors the PSTN usage for the serviced call. The PSTN usage information may be reported to the billing account management server 706 by the telephony bridging circuitry 702 during or at completion of the PSTN call (operation 724). Such PSTN usage information 724 may include the toll incurred by telephony bridging circuitry 702 in establishing the call to receiving PSTN telephony circuitry 708. The billing and account management service 706 uses this information to bill a calling subscriber or to place such charges on account for further processing in a bartering arrangement or in another transaction. The telephony bridging circuitry 702 may receive a caller/device database record 716 from the billing and account management service 708 that provides additional information regarding the calling VoIP telephony circuitry 704. This information may be used during call setup, during call servicing, or later when the telephony bridging circuitry 702 desires perhaps to access other telephony bridging circuitry 702.

FIG. 8 is an operational flow diagram illustrating a plurality of PSTN to VoIP telephony operations according to embodiments of the present invention. With these operations, calling PSTN telephony circuitry 804 establishes a call to receiving VoIP telephony circuitry 806 via telephony bridging circuitry 802. In initiating the call, calling PSTN telephony circuitry 804 sends a PSTN call with bridging indication request 812 to the telephony bridging circuitry 802. In response to this request, the telephony bridging circuitry 802 interacts with the calling PSTN telephony circuitry 802 to receive information regarding the desired destination of the call. The interaction could be via a keypad interface, a voicemail vectoring interface, a voice recognition system interface, or via another interface allowing the caller using the calling PSTN telephony circuitry 804 to provide sufficient information to the telephony bridging circuitry 802 to complete the call.

In response to the information received from the calling PSTN telephony circuitry 804 the telephony bridging circuitry 802 sends a caller/device database record request 814 to local client storage and/or billing and account management servers 808 and 810, respectively. This request 814 may include the handle of a subscriber associated with receiving Internet telephony circuitry 806, and/or additional information. In response, local client storage 808 and/or the billing and account management server 810 sends a record 816 to the telephony bridging circuitry 802 that includes billing information, permissions information, security information, override control information, VoIP handles to phone number mapping information, and/or additional information. This information enables the telephony bridging circuitry 802 to determine an IP address of the receiving VoIP telephony circuitry 806.

The telephony bridging circuitry 802 then sends an Internet call setup request 818 to the receiving Internet telephony circuitry 806. This call setup request 818 may include Internet call setup interaction with which the telephony bridging circuitry 802 attempts to establish a VoIP call with a local user of receiving Internet telephony circuitry 806. The Internet call setup interaction may include the identity of a particular local user of the receiving Internet telephony circuitry 806 when the receiving Internet telephony circuitry 806 services a plurality of local users. At such case, the receiving Internet telephony circuitry 806 would provide the unique announcement corresponding to the particular user or subscriber.

Receiving Internet telephony circuitry 806 then allows the telephony bridging circuitry 802 to establish a VoIP call path. The telephony bridging circuitry 802 also establishes a PSTN call path with the calling PSTN telephony circuitry 804 if such path has not previously been established. Then, the telephony bridging circuitry 802 bridges the call between the calling PSTN telephony circuitry 804 and receiving Internet telephony circuitry 806 until it is either completed or interrupted by a local subscriber. As was the case with the previous instruction of FIG. 7, a local subscriber may interrupt the bridged call based upon the particular security and override control settings for the call.

As one of average skill in the art will appreciate, the term “communicatively coupled,” as may be used herein, includes wireless and wired, direct coupling and indirect coupling via another component, element, circuit, or module. As one of average skill in the art will also appreciate, inferred coupling (i.e., where one element is coupled to another element by inference) includes wireless and wired, direct and indirect coupling between two elements in the same manner as “communicatively coupled”.

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention.

One of average skill in the art will also recognize that the functional building blocks, and other illustrative blocks, modules and components herein, can be implemented as illustrated or by discrete components, application specific integrated circuits, processors executing appropriate software and the like or any combination thereof.

Moreover, although described in detail for purposes of clarity and understanding by way of the aforementioned embodiments, the present invention is not limited to such embodiments. It will be obvious to one of average skill in the art that various changes and modifications may be practiced within the spirit and scope of the invention, as limited only by the scope of the appended claims.

What is claimed is:

1. In an infrastructure supporting both Voice over Internet Protocol (VoIP) telephony via the Internet and Public Switched Telephone Network (PSTN) telephony via the PSTN, a system comprising:
a plurality of client telephony bridging devices communicatively coupled to both the Internet and to the PSTN and operable to bridge calls between the Internet and the PSTN;
server processing circuitry communicatively coupled to the plurality of client telephony bridging devices and operable to enact access rules for the plurality of client telephony bridging devices and for a plurality of subscribers, the server operable to:
receive a voice call setup request from a calling voice terminal via the Internet, the voice call setup request identifying a subscriber;
obtain access rules for the subscriber; and
based upon the access rules for the subscriber and the access rules for the plurality of client telephony bridging devices, select a servicing telephony bridging device from the plurality of client telephony bridging devices; and
the servicing client telephony bridging device operable to bridge an incoming call for the calling voice terminal between the Internet and the PSTN.

2. The system of claim 1, wherein the server processing circuitry resides within a server communicatively coupled to the plurality of client telephony bridging devices via the Internet.

3. The system of claim 1, wherein the server processing circuitry resides within at least one of the plurality of client telephony bridging devices.

4. The system of claim 1, wherein the access rules comprise bartering arrangement rules respective to subscribers corresponding to the plurality of client telephony bridging devices.

5. The system of claim 1, wherein the server processing circuitry is further operable to:
monitor client telephony bridging device usage by a subscriber; and
alter access rules for the subscriber based upon the usage by the subscriber.

6. The system of claim 1, wherein the server processing circuitry is further operable to:
monitor usage of a client telephony bridging device; and
alter access rules for the client telephony bridging based upon the usage.

7. The system of claim 1, wherein:
a client telephony bridging device is operable to report to the server processing circuitry its usage by a subscriber; and
based upon the reported usage, the server processing circuitry operable to alter access rules corresponding to the subscriber to limit access by the subscriber to the plurality of client telephony bridging devices.

8. The system of claim 1, wherein each of the plurality of client telephony bridging devices have associated therewith:
at least one Internet Protocol (IP) address; and
PSTN local connectivity information.

9. The system of claim 8, wherein the PSTN local connectivity information comprising:
a local area code; and
a local exchange prefix number.

10. The system of claim 1, wherein:
a client telephony bridging device is operable to:
receive a use request by a local subscriber while bridging a voice call for a non-local subscriber; and
report to the server processing circuitry that a local subscriber use request has been received; and
based upon the report, the server processing circuitry operable to initiate handover of the voice call to a differing client telephony bridging device.

11. The system of claim 1, wherein a client telephony bridging device is operable to:
receive a use request by a local subscriber while bridging a voice call for a non-local subscriber;
provide an indication to the non-local subscriber that voice call bridging service will be terminated;
terminate the voice bridging service for the non-local subscriber; and
provide access to the local subscriber.

12. The system of claim 1, wherein a client telephony bridging device is operable to:
receive a use request by a local subscriber while bridging a voice call for a non-local subscriber;
send a message to the server processing circuitry indicating that the local subscriber has requested use;
receive a response from the server processing circuitry; and
based upon the response, denying use to the local subscriber.

13. The system of claim 1, wherein access rules for a particular client telephony bridging device have:
a first level of access for a local subscriber; and
a second level of access for a non-local subscriber.

14. The system of claim 1, wherein access rules for a particular client telephony bridging device have:
a first level of access for during a first period of time; and
a second level of access for a second period of time that differs from the first period of time.

15. The system of claim 1, wherein a first client telephony bridging device is operable to:
determine that its local PSTN connection cannot support a PSTN call;
send a request to the server processing circuitry, requesting access to the PSTN via a second client telephony bridging device; and
access the PSTN via the Internet and the second client telephony bridging device.

16. A client telephony bridging device comprising:
a user interface;
a packet data interface operable to support Voice over Internet Protocol (VoIP) telephony and communicatively coupled to the Internet;
a Public Switched Telephone Network Telephony (PSTN) interface operable to support PSTN telephony and communicatively coupled to the PSTN; and
processing circuitry communicatively coupled to the user interface, the packet data interface, and the PSTN interface and operable to:
receive a request via the user interface to initiate a PSTN voice call to a PSTN telephone number;
send a PSTN voice call request that includes the PSTN telephone number via the packet data network interface;
receive a response via the packet data network interface that includes an Internet Protocol (IP) address of a remote client telephony bridging device; and
send a voice call servicing request that includes the PSTN telephone number via the packet data network interface to the remote client telephony bridging device; and
service the PSTN voice call via the user interface, the packet data network interface, and the remote client telephony bridging device.

17. The client telephony bridging device of claim 16, wherein the processing circuitry is further operable to:
monitor client telephony bridging device usage by a non-local subscriber; and
report to a remote server the client telephony bridging usage by the non-local subscriber.

18. The client telephony bridging device of claim 16, wherein the processing circuitry is further operable to:
monitor usage of a remote client telephony bridging device by a local subscriber; and
report to a remote server the usage of the remote client telephony bridging device by the local subscriber.

19. The client telephony bridging device of claim 16, wherein the processing circuitry is further operable to:
receive a use request by a local subscriber while bridging a voice call for a non-local subscriber;
send a message to the server processing circuitry indicating that the local subscriber has requested use;
receive a response from the server processing circuitry; and
based upon the response, deny use to the local subscriber.

20. A client telephony bridging device comprising:
a user interface;
a packet data interface operable to support Voice over Internet Protocol (VoIP) telephony and communicatively coupled to the Internet;
a Public Switched Telephone Network Telephony (PSTN) interface operable to support PSTN telephony and communicatively coupled to the PSTN; and
processing circuitry communicatively coupled to the user interface, the packet data interface, and the PSTN interface and operable to:
receive a request via the user interface to initiate a PSTN voice call to a PSTN telephone number;
determine that access to the PSTN via the PSTN interface is not available;
send a PSTN voice call request that includes the PSTN telephone number via the packet data network interface;
receive a response via the packet data network interface that includes an Internet Protocol (IP) address of a remote client telephony bridging device; and
send a voice call servicing request that includes the PSTN telephone number via the packet data network interface to the remote client telephony bridging device; and
service the PSTN voice call via the user interface, the packet data network interface, and the remote client telephony bridging device.

21. The client telephony bridging device of claim 20, wherein access to the PSTN via the PSTN interface is not available because the client telephony bridging device is providing voice telephony bridging for a remote subscriber.

22. The client telephony bridging device of claim 20, wherein access to the PSTN via the PSTN interface is not available because the PSTN is inoperable.

23. Telephony circuitry used in a first telephony device of a communication infrastructure, the communication infrastructure supporting a second telephony device via a packet switched network and a third telephony device via a circuit switched network, one of the second telephony device and the third telephony device comprising a calling telephony device, another of the first telephony device and the second telephony device comprising a receiving telephony device, the telephony circuitry comprising:
first interface circuitry that supports a pathway to the calling telephony device;
second interface circuitry that supports a pathway to the receiving telephony device;
user interface circuitry;
processing circuitry operable to respond to a first call setup indication received from the calling telephony device via the first interface circuitry by delivering an announcement signal to the user interface circuitry, and, upon receiving a first pick up indication from the user interface circuitry, supporting communication between the calling telephony device and the user interface circuitry; and
the processing circuitry operable to respond to a second call setup indication received from the calling telephony device via the first interface circuitry by delivering a call setup request to the receiving telephony device via the second interface circuitry, and, upon receiving a second pick up indication from the receiving telephony device via the second interface, bridge communications between the calling telephony device and the receiving telephony device.

24. The telephony circuitry of claim 23, wherein:
the first interface circuitry is a packet data network interface communicatively coupled to the Internet; and
the second interface circuitry is a Public Switched Telephone Network (PSTN) interface communicatively coupled to the PSTN.

25. The telephony circuitry of claim 23, wherein:
the first interface circuitry is a Public Switched Telephone Network (PSTN) interface communicatively coupled to the PSTN; and
the second interface circuitry is a packet data network interface communicatively coupled to the Internet.

26. The telephony circuitry of claim 23, the processing circuitry further operable to:
receive a call initiation request from a user via the user interface;
determine that the call request conflicts with a currently bridged call serviced by the first interface and the second interface;
when first override control applies, interrupt the currently bridged call to service the call initiation request; and
when second override control applies, deny the call initiation request.

27. The telephony circuitry of claim 23, wherein the processing circuitry is further operable to:
interact with the calling telephony device to obtain call setup information from the calling telephony device; and
use the call setup information obtained from the calling telephony device in preparing the call setup request delivered to the receiving telephony device.

28. The telephony circuitry of claim 27, wherein the call setup information includes an Internet Protocol address of the receiving telephony device.

29. The telephony circuitry of claim 27, wherein the call setup information includes a PSTN number of the receiving telephony device.

30. The telephony circuitry of claim 23, wherein the processing circuitry is further operable to:
determine whether the calling telephony device has permission to use the telephony circuitry for call bridging;
when the calling telephony device has permission to use the telephony circuitry for call bridging, deliver the call setup request to the receiving telephony device; and
when the calling telephony device does not have permission to use the telephony circuitry for call bridging, do not deliver the call setup request to the receiving telephony device.

31. The telephony circuitry of claim 23, wherein the processing circuitry is further operable to establish a three-way call with the user interface, the first interface circuitry with the calling telephony device, and the second interface with the receiving telephony device.

32. The telephony circuitry of claim 23, wherein the processing circuitry is further operable to:
receive bridging instructions via the user interface circuitry regarding bridging of calls; and
based upon the bridge instructions, bridge at least one incoming call via the first interface circuitry and the second interface circuitry.

33. The telephony circuitry of claim 32, wherein based upon the bridging instructions, the processing circuitry is further operable to redirect a call arriving via the first interface circuitry or the second interface circuitry.

34. The telephony circuitry of claim 23, wherein the processing circuitry is further operable to prevent a user from listening to the bridged communication via the user interface circuitry.

35. The telephony circuitry of claim 23, wherein the processing circuitry is further operable to:
receive a bridging disable indication via the user interface; and
preclude bridging of communications between the first interface circuitry and the second interface circuitry based upon the bridging disable indication.

36. The telephony circuitry of claim 23, wherein the processing circuitry is further operable to:
receive time based bridging rules via the user interface; and
preclude bridging of communications between the first interface circuitry and the second interface circuitry based upon the time based bridging rules.

37. The telephony circuitry of claim 23, wherein the processing circuitry is further operable to prevent a local user from listening to bridged communications via the user interface circuitry.

38. The telephony circuitry of claim 23, wherein the processing circuitry is further operable to:
monitor a duration of the bridged communications; and
report the duration of the bridged communications to remotely located server circuitry.

39. A method for operating telephony circuitry comprising:
responding to a first call setup indication received from a calling telephony device via a first interface by delivering an announcement signal to user interface circuitry;
upon receiving a pick up indication via the user interface circuitry, supporting communication between the calling telephony device and the user interface circuitry;
responding to a second call setup indication received from the calling telephony device via the first interface circuitry by delivering a call setup request to a receiving telephony device via the second interface circuitry; and
upon receiving a second pick up indication from the receiving telephony device via the second interface, bridging a call between the calling telephony device and the receiving telephony device.

40. The method of claim 39, wherein the first call setup indication is received via the Internet; and
the call setup request is delivered to the receiving telephony device via the Public Switched Telephone Network (PSTN).

41. The method of claim 39, wherein:
the first call setup indication is received via the Public Switched Telephone Network (PSTN); and
the call setup request is delivered to the receiving telephony device via the Internet.

42. The method of claim 39, further comprising:
receiving a call initiation request from a user via the user interface;
determining that the call request conflicts with the currently bridged call;
when first override control applies, interrupting the currently bridged call to service the call initiation request; and
when second override control applies, denying the call initiation request.

43. The method of claim 39, further comprising:
interacting with the calling telephony device to obtain call setup information from the calling telephony device; and
using the call setup information obtained from the calling telephony device in preparing the call setup request delivered to the receiving telephony device.

44. The method of claim 39, further comprising:
determining whether the calling telephony device has permission to use the telephony circuitry for call bridging;
when the calling telephony device has permission to use the telephony circuitry for call bridging, delivering the call setup request to the receiving telephony device; and
when the calling telephony device does not have permission to use the telephony circuitry for call bridging, not delivering the call setup request to the receiving telephony device.

45. The method of claim 39, further comprising establishing a three-way call with a user via the user interface, the calling telephony device via the first interface circuitry, and the receiving telephony device via the second interface.

46. The method of claim 39, further comprising:
receiving bridging instructions via the user interface circuitry regarding bridging of calls; and
based upon the bridge instructions, bridging at least one incoming call via the first interface circuitry and the second interface circuitry.

47. The method of claim 39, further comprising redirecting a call arriving via the first interface circuitry or the second interface circuitry.

48. The method of claim 39, further comprising preventing a user from listening to the bridged communication via the user interface circuitry.

49. The method of claim 39, further comprising:
receiving a bridging disable indication via the user interface; and
precluding bridging of communications between the first interface circuitry and the second interface circuitry based upon the bridging disable indication.

50. The method of claim 39, further comprising:
receiving time based bridging rules via the user interface; and
precluding bridging of communications between the first interface circuitry and the second interface circuitry based upon the time based bridging rules.

51. The method of claim 39, further comprising preventing a local user from listening to bridged communications via the user interface circuitry.

52. The method of claim 39, further comprising:
monitoring a duration of the bridged call; and
reporting the duration of the bridged call to remotely located server circuitry.
